(19) United States
(12) Patent Application Publication
(10) Pub. No.: US 2008/0070120 A1
(43) Pub. Date: Mar. 20, 2008

(54) Non-aqueous electrolyte secondary battery and making method

(75) Inventors: Satoru Miyawaki, Annaka-shi (JP); Mikio Aramata, Annaka-shi (JP); Meguru Kashida, Annaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Shin-Etsu Chemical Co., Ltd., Tokyo (JP)

(21) Appl. No.: 11/898,412

(22) Filed: Sep. 12, 2007

(30) Foreign Application Priority Data
Sep. 14, 2006 (JP) 2006-248967

(51) Int. Cl. H01M 4/40

(52) U.S. Cl. 429/231.95; 156/279

(57) ABSTRACT

A non-aqueous electrolyte secondary battery comprises a negative electrode comprising a negative electrode active material containing silicon capable of intercalating and deintercalating lithium ions, a positive electrode comprising a positive electrode active material containing an oxide, sulfide or organic polymer capable of intercalating and deintercalating lithium ions, and a non-aqueous electrolyte solution containing a lithium salt. A lithium-containing film is coated or laminated to the negative electrode to make up an irreversible capacity of lithium to be left in the negative electrode.

### CROSS-REFERENCE TO RELATED APPLICATION

This non-provisional application claims priority under 35 U.S.C. §119(a) on Patent Application No. 2006-248967 filed in Japan on Sep. 14, 2006, the entire contents of which are hereby incorporated by reference.

### TECHNICAL FIELD

This invention relates to a non-aqueous secondary battery and a method for preparing the same. More particularly, it relates to a lithium ion secondary battery and a method for preparing the same.

### BACKGROUND ART

As the portable power source for laptop computers, mobile phones, digital cameras and the like, there is an increasing demand for lithium ion secondary batteries featuring a high energy density. A focus is also directed to lithium ion secondary batteries as the power source for electric automobiles which are desired to reach a practical level because of environment friendliness.

Conventional lithium ion secondary batteries use carbonaceous materials as the active material in the negative electrode. To meet the recent demand for higher capacities, it is envisioned that silicon and other metals capable of alloying with lithium and oxides thereof which are expected to provide a high charge/discharge capacity are used as the negative electrode active material. The use of alloying metals as the active material is expected to provide a high capacity, but can cause an irreversible phenomenon that once lithium in the positive electrode material is introduced into the negative electrode material during the first charging step, not all lithium ions are taken out during subsequent discharge, with a certain amount being left within the negative electrode. It becomes an irreversible capacity of lithium. This undesirably results in a battery having a reduced discharge capacity and a degraded capability. A number of measures for solving this problem have been proposed and practiced as disclosed in numerous patents.

Specifically, JP-A 5-226003 corresponding to U.S. Pat. No. 5,316,875 describes to make up an amount corresponding to the irreversible capacity of an organic lithium compound; JP-A 10-223259 describes placement of metallic lithium at the top of a battery case; and Japanese Patent No. 3403858 describes a distribution of lithium in a cross-sectional direction of the positive electrode. JP-A 2003-234125 proposes to improve cycle performance by attaching a metallic lithium foil to a battery case, and effecting, after introduction of a non-aqueous electrolyte solution, initial charging at a negative electrode potential E in the range 2.5 V<E<3.2 V for thereby restraining impurity metal ions from precipitating and preventing microscopic short-circuiting. Although these proposals are effective against a decline of battery capability, they are difficult to implement industrially because of complexity of an overall process, cumbersome operation in a lithium-inert environment, and limited working site.

### DISCLOSURE OF THE INVENTION

An object of the invention is to provide a non-aqueous secondary battery which is designed to make up an irreversible capacity of lithium to be left in the negative electrode, improved in battery capability, and easy to manipulate during its manufacture; and a method for preparing the same.

The inventors have found that the above object is attained by a simple means which ensures easy manipulation near a dew point of −40° C. After metallic lithium is powdered into a metallic lithium powder, a lithium-containing film is prepared therefrom and attached to the negative electrode, or the lithium powder is coated to the negative electrode for thereby making up an irreversible capacity of lithium to be left in the negative electrode. This means improves the battery capability.

In a first aspect, the invention provides a non-aqueous electrolyte secondary battery comprising a negative electrode comprising a negative electrode active material containing silicon capable of intercalating and deintercalating lithium ions, a positive electrode comprising a positive electrode active material containing an oxide, sulfide or organic polymer capable of intercalating and deintercalating lithium ions, and a non-aqueous electrolyte solution containing a lithium salt. The negative electrode has a lithium-containing film at least at the positive electrode side. In a preferred embodiment, the lithium-containing film comprises a metallic lithium powder which is optionally surface coated with an organic rubber, organic resin or metal carbonate, a binder, and an electric conductive agent. In another preferred embodiment, the negative electrode has a current collector sheet having one surface and another (or the opposite) surface. The negative electrode active material layer may be formed on one surface of the current collector sheet, and the lithium-containing film is formed on the negative electrode active material layer. Alternatively, the negative electrode active material layer may be formed on each surface of the current collector sheet and the lithium-containing film is formed on each negative electrode active material layer.

In a second aspect, the invention provides a method for manufacturing a non-aqueous electrolyte secondary battery comprising a negative electrode comprising a negative electrode active material containing silicon capable of intercalating and deintercalating lithium ions, a positive electrode comprising a positive electrode active material containing an oxide, sulfide or organic polymer capable of intercalating and deintercalating lithium ions, and a non-aqueous electrolyte solution containing a lithium salt, said method comprising the step of forming a lithium-containing film to at least the positive electrode side of the negative electrode. In a preferred embodiment, the step of coating a lithium-containing film includes coating a mixture comprising a metallic lithium powder which is optionally surface coated with an organic rubber, organic resin or metal carbonate, a binder, and an electric conductive agent directly to at least the positive electrode side of the negative electrode. In another preferred embodiment, the step of laminating a lithium-containing film includes previously forming a lithium-containing film from a mixture comprising a metallic lithium powder which is optionally surface coated with an organic rubber, organic resin or metal carbonate, a binder, and an electric conductive agent and laminating the film to at least the positive electrode side of the negative electrode. In a further preferred embodiment, a current collector sheet having one surface and another (or the opposite) surface for the negative electrode is provided. The step of forming the negative electrode active material layer on one surface of the current collector sheet is included. Moreover, the step of coating the mixture directly on the negative electrode active material layer or the step of laminating the film on the negative electrode active material layer may be included to form the lithium-containing film. Alternatively, the step of coating the mixture directly on each negative electrode active material layer or the step of laminating the film on each negative electrode active material layer may be included to form the lithium-containing films on the negative electrode active materials respectively.

### BENEFITS OF THE INVENTION

According to the invention, an irreversible capacity of lithium to be left in the negative electrode can be made up by a simple means. This means is easily manipulated near a dew point of −40° C. A non-aqueous secondary battery with an improved capability is available.

### DESCRIPTION OF THE PREFERRED EMBODIMENTS

The invention relates to a non-aqueous electrolyte secondary battery comprising a negative electrode comprising a negative electrode active material containing silicon capable of intercalating and deintercalating lithium ions, a positive electrode comprising a positive electrode active material containing an oxide, sulfide or organic polymer capable of intercalating and deintercalating lithium ions, and a non-aqueous electrolyte solution containing a lithium salt.

The positive electrode active materials used herein include oxides, sulfides and organic polymers which are capable of intercalating and deintercalating lithium ions. They may be used alone or in admixture. Examples include sulfides and oxides of metals excluding lithium such as TiS₂, MoS₂, NbS₂, ZrS₂, VS₂, V₂O₅, MoO₃, Mg(V₃O₈ )₂, and lithium and lithium-containing complex oxides. Composite metals such as NbSe₂ are also useful. For increasing the energy density, lithium complex oxides based on LiM(Met)ₓO₂ are preferred wherein Met is preferably at least one element of cobalt, nickel, iron and manganese and x has a value in the range: 0.05≦x≦1.10. Illustrative examples of the lithium complex oxides include LiCoO₂, LiNiO₂, LiFeO₂, and LiₓNi_{y}Co_{1-y}O₂ having a layer structure wherein 0.05≦x≦1.10 and 0≦y≦1, LiMn₂O₄ having a spinel structure, and rhombic LiMnO₂. Also used is a substitutional spinel type manganese compound adapted for high voltage operation which is LiMetₓMn₁₋ₓO₄ wherein Met is titanium, chromium, iron, cobalt, copper, zinc or the like and 0≦x≦1.

It is noted that the lithium complex oxide described above is prepared, for example, by grinding and mixing a carbonate, nitrate, chloride or hydroxide of lithium and a carbonate, nitrate, oxide or hydroxide of a transition metal in accordance with the desired composition, and firing at a temperature in the range of 600 to 1,000° C. in an oxygen atmosphere.

Organic polymers may also be used as the positive electrode active material. Examples include electroconductive polymers such as polyacetylene, polypyrrole, polyparaphenylene, polyaniline, polythiophene, polyacene, and polysulfide.

The negative electrode active materials used herein include silicon-containing active materials capable of intercalating and deintercalating lithium ions. Examples include high purity silicon powder having metal impurity concentrations of up to 1 ppm; silicon powder of chemical grade which is obtained by washing with hydrochloric acid, and treating with hydrofluoric acid or a mixture of hydrofluoric acid and nitric acid for removing metal impurities; silicon powder obtained by metallurgically purifying metallic silicon and powdering; alloys of the foregoing, lower oxides or partial oxides of silicon, nitrides or partial nitrides of silicon, mixtures of the foregoing with carbon materials for electric conductive treatment, alloy forms of the foregoing by mechanical alloying, forms of the foregoing coated with conductive substances such as metals by sputtering or plating, and forms of the foregoing having carbon deposited thereon from organic gases.

One preferred negative electrode active material is particles of a silicon base compound, typically silicon dioxide, having silicon microcrystals with a size of 1 to 500 nm dispersed therein, which particles are surface coated with carbon, as disclosed in JP-A 2004-47404 corresponding to US 2003-215711A.

Any desired method may be used in the preparation of positive and negative electrodes. Electrodes are generally prepared by adding an active material, binder, conductive agent and the like to a solvent to form a slurry, applying the slurry to a current collector sheet, drying and press bonding. The binder used herein is usually selected from polyvinylidene fluoride, polytetrafluoroethylene, styrene-butadiene rubber, isoprene rubber, and various polyimide resins. The conductive agent used herein is usually selected from carbonaceous materials such as graphite and carbon black, and metal materials such as copper and nickel. As the current collector, aluminum and aluminum alloys are usually employed for the positive electrode, and metals such as copper, stainless steel and nickel and alloys thereof employed for the negative electrode.

The separator disposed between the positive and negative electrodes is not particularly limited as long as it is stable against the electrolytic solution and able to hold the solution. Examples include porous sheets and non-woven fabrics of polyolefins such as polyethylene and polypropylene.

The non-aqueous electrolytic solution used herein comprises an electrolyte salt and a non-aqueous solvent. Exemplary of the electrolyte salt used herein are light metal salts. Suitable light metal salts include salts of alkali metals such as lithium, sodium and potassium, salts of alkaline earth metals such as magnesium and calcium, and aluminum salts. A choice may be made among these salts and mixtures thereof depending on a particular purpose. Examples of suitable lithium salts include LiBF₄, LiClO₄, LiPF₆, LiAsF₆, CF₃SO₃Li, (CF₃SO₂)₂NLi, C₄F₉SO₃Li, CF₃CO₂Li, (CF₃CO₂)₂NLi, C₆F₅SO₃Li, C₈F₁₇SO₃Li, (C₂F₅SO₂)₂NLi, (C₄F₉SO₂)(CF₃SO₂)NLi, (FSO₂C₆F₄)(CF₃SO₂)NLi, ((CF₃)₂CHOSO₂)₂NLi, (CF₃SO₂)₃CLi, (3,5-(CF₃)₂C₆F₃)₄BLi, LiCF₃, LiAlCl₄, and C₄BO₈Li, which may be used alone or in admixture.

From the electric conductivity aspect, the electrolyte salt is preferably present in a concentration of 0.5 to 2.0 mole/liter of the non-aqueous electrolytic solution. The electrolyte should preferably have a conductivity of at least 0.01 S/m at a temperature of 25° C., which may be adjusted in terms of the type and concentration of the electrolyte salt.

The non-aqueous solvent used herein is not particularly limited as long as it can serve for the non-aqueous electrolytic solution. Suitable solvents include aprotic high-dielectric-constant solvents such as ethylene carbonate, propylene carbonate, butylene carbonate, and γ-butyrolactone; and aprotic low-viscosity solvents such as dimethyl carbonate, ethyl methyl carbonate, diethyl carbonate, methyl propyl carbonate, dipropyl carbonate, diethyl ether, tetrahydrofuran, 1,2-dimethoxyethane, 1,2-diethoxyethane, 1,3-dioxolane, sulfolane, methylsulfolane, acetonitrile, propionitrile, anisole, acetic acid esters, e.g., methyl acetate and propionic acid esters. It is desirable to use a mixture of an aprotic high-dielectric-constant solvent and an aprotic low-viscosity solvent in a proper ratio. It is also acceptable to use ionic liquids containing imidazolium, ammonium and pyridinium cations. The counter anions are not particularly limited and include BF₄⁻, PF₆⁻ and (CF₃SO₂)₂N⁻. The ionic liquid may be used in admixture with the foregoing non-aqueous solvent.

Where a solid electrolyte or gel electrolyte is desired, a silicone gel, silicone polyether gel, acrylic gel, acrylonitrile gel, poly(vinylidene fluoride) or the like may be included in a polymer form. These ingredients may be polymerized prior to or after casting. They may be used alone or in admixture.

If desired, various additives may be added to the non-aqueous electrolytic solution of the invention. Examples include an additive for improving cycle life such as vinylene carbonate, methyl vinylene carbonate, ethyl vinylene carbonate and 4-vinylethylene carbonate, an additive for preventing over-charging such as biphenyl, alkylbiphenyl, cyclohexylbenzene, t-butylbenzene, diphenyl ether, and benzofuran, and various carbonate compounds, carboxylic acid anhydrides, nitrogen- and sulfur-containing compounds for acid removal and water removal purposes.

The secondary battery may take any desired shape. In general, the battery is of the coin type wherein electrodes and a separator, all punched into coin shape, are stacked, or of the cylinder type wherein electrode sheets and a separator are spirally wound.

According to the invention, the non-aqueous electrolyte secondary battery is characterized in that a lithium-containing film is formed by coating or laminating to the negative electrode described above at least at the positive electrode saide.

Although the silicon-containing negative electrode active material described above has a high charge/discharge capacity as compared with traditional graphite, it suffers from the problem of an irreversible capacity of lithium that once lithium in the positive electrode material is introduced into the negative electrode material during the first charging step, not all lithium ions are taken out during subsequent discharge, with a certain amount being left within the negative electrode. In particular, silicon oxide which is a lower oxide of silicon exhibits excellent cycle characteristics, but causes a more irreversible capacity of lithium. The problem must be overcome before the silicon-containing materials can be practically accepted. The problem can be overcome by forming a lithium-containing film.

The lithium-containing film is preferably a film of a mixture containing a metallic lithium powder which is optionally surface coated, a binder, and an electric conductive agent.

The metallic lithium powder used herein is preferably a stabilized one. Once a lithium powder is stabilized, the lithium powder is no longer altered even in a dry chamber with a dew point of approximately −40° C. The stabilization of lithium powder means that a surface of a lithium powder (i.e., surfaces of lithium particles) is coated with substances having environment stability including organic rubbers such as nitrile-butadiene rubber (NBR) and styrene-butadiene rubber (SBR), organic resins such as ethylene-vinyl alcohol (EVA) copolymer resins, and inorganic compounds such as metal carbonates like Li₂CO₃. Such stabilized lithium powder is commercially available, for example, under the trade name of SLMP from FMC Corp. and lithium powder from Aldrich.

The binder used herein may be selected from polyvinylidene fluoride, styrene-butadiene copolymers, polytetrafluoroethylene resins, tributadiene rubber, ethylene-vinyl alcohol copolymer resins, polyamide resins, polyimide resins, and polyamide-imide resins. The binder is preferably used in an amount of 0.1 to 70 parts, more preferably 0.2 to 10 parts by weight per 100 parts by weight of the metallic lithium.

The conductive agent used herein may be selected from acetylene black, graphite, carbon fibers, and powder or fiber form of metals such as copper, stainless steel, and nickel and alloys comprising at least two of the foregoing. The conductive agent is preferably used in an amount of 0.1 to 70 parts, more preferably 0.2 to 10 parts by weight per 100 parts by weight of the metallic lithium.

To the mixture of metallic lithium powder, binder and conductive agent, a dry solvent selected from N-methylpyrrolidone, toluene, xylene, methyl ethyl ketone and the like is added to form a slurry. In a nitrogen glove box having a dew point of −40° C., the slurry is coated to the negative electrode and dried, yielding a lithium-coated negative electrode. Alternatively, the slurry is formed into a film, and the lithium-containing film is laminated to the negative electrode and dried, yielding a lithium-laminated negative electrode.

In this case, the lithium-containing film is formed on the negative electrode so that the film is present at least at the positive electrode side of the negative electrode. Preferably, the lithium-containing film is formed by coating or laminating on the negative electrode active material layer formed on the collector sheet for the negative electrode. Thus, it is recommended that the current collector has the negative electrode active material layer on one surface of the collector or the negative electrode active material layers on both surfaces of the collector. The lithium-containing film is formed on each negative electrode active material layer. The lithium-containing film is positioned so that the film is opposed to the positive electrode. The negative electrode in which the negative electrode active material layer having the lithium-containing film thereon is formed on one surface of the current collector sheet is effective for coin type batteries. The negative electrode in which the negative electrode active material layers are formed on the both surfaces of the current collector sheet and the lithium-containing sheets are formed on the negative electrode active material layers respectively is effective for cylinder type batteries.

In the non-aqueous electrolyte secondary battery, the lithium-containing film behaves in such a manner that the lithium formed on the current collector sheet is dispersed in the interior of the negative electrode active material layer during the first charge step. Because the lithium-containing film is utilized to compensate for an irreversible capacity component in the negative electrode, the amount of lithium added is desirably less than or equal to an amount sufficient to compensate for an irreversible capacity component in the negative electrode. An appropriate amount of lithium added varies with the quantity and type of the negative electrode active material, and the irreversible capacity component is reduced in proportion to the amount of lithium added. A too much amount of lithium would allow lithium to precipitate on the negative electrode and rather reduce the battery capacity. Accordingly, an appropriate amount of lithium added is preferably determined after an initial efficiency of the negative electrode is separately measured, and also in accordance with the thickness (or amount) of the negative electrode in the battery design.

### EXAMPLE

Examples and Comparative Example are given below for further illustrating the invention, but are not construed as limiting the invention thereto. All percents are by weight.

### Example 1

[Preparation of Negative Electrode Active Material (Conductive Silicon Composite)]

A conductive silicon composite serving as negative electrode active material was prepared as follows, in accordance with the teaching of JP-A 2004-47404.

A powder mixture of equimolar amounts of silicon dioxide powder (BET specific surface area=200 m²/g) and metallic silicon powder of chemical grade (BET specific surface area=4 m²/g) was heat treated in a hot vacuum atmosphere at 1,350° C. and 0.1 Torr while evolving SiOx gas was fed to a water-cooled stainless steel substrate for precipitation. The precipitate was recovered and milled in hexane on a ball mill for 5 hours, obtaining a silicon oxide powder (SiOx, x=1.02) having d₅₀=8 μm. The powder was analyzed by X-ray diffractometry using Cu—Kα ray, finding that it consisted of amorphous silicon oxide (SiOx) particles.

The silicon oxide powder was placed in a rotary kiln reactor, where disproportionation of silicon oxide and thermal CVD were concurrently effected in a methane/argon gas mixture stream at 1,150° C. for an average residence time of about 2 hours. At the end of operation, the reactor was cooled down and a black powder was recovered. The powder had a deposited carbon content of 22.0%. On X-ray diffractometry analysis of the black powder, unlike the silicon oxide powder, a diffraction peak attributable to Si(111) appeared around 2θ=28.40. Crystal size determination by the Scherrer equation from the half-value width of the diffraction peak showed that silicon grains dispersed in silicon dioxide had a size of 11 nm. This implies that a conductive silicon composite powder having submicron silicon (Si) grains dispersed in silicon dioxide (SiO₂) was obtained.

[Preparation of Negative Electrode]

A negative electrode was prepared by adding 10% of polyimide to 5 g of the conductive silicon composite powder and further adding N-methylpyrrolidone to form a slurry. The slurry was coated onto one surface of a copper foil of 20 μm thick (coating weight of conductive silicon composite powder=1.5 mg/cm²) and vacuum dried at 80° C. for 1 hour. The coated foil was shaped under pressure by means of a roller press and vacuum dried at 350° C. for 1 hour, obtaining a negative electrode.

[Preparation of Lithium-Containing Paste]

To 1 g of lithium powder with a particle size of 50-150 μm (Aldrich, Cat. No. 590584) was added 0.5 g of acetylene black. Polyvinylidene fluoride was then added in a concentration of 3%. To this composition, N-methylpyrrolidone which had been dried through a molecular sieve was added to form a slurry. The slurry was coated onto another surface of the copper foil of the above-prepared negative electrode in a nitrogen glove box with a dew point of −40° C. and vacuum dried at 100° C. for one hour to form a lithium-containing film on the negative electrode, from which a disc of 2 cm² was punched out.

[Battery Assembly]

From a single layer sheet using LiCoO₂ as the active material and an aluminum foil as the current collector (trade name Pioxcel C-100 by Pionics Co., Ltd.), a disc of 2 cm² was punched out as a positive electrode.

A testing lithium ion secondary battery was assembled in a glove box (dew point up to −80° C.), by using the positive electrode, the lithium-coated negative electrode, a porous film of polyethylene having a thickness of 30 μm as a separator, and a non-aqueous electrolyte solution of lithium hexafluorophosphate as a non-aqueous electrolyte in a 1/1 (volume ratio) mixture of ethylene carbonate and diethyl carbonate in a concentration of 1 mole/liter, and stacking them in the order of positive electrode, separator and negative electrode in a 2032 type coin battery housing and introducing the electrolyte solution. In this case, the lithium-containing film is positioned at the positive electrode side.

The battery was held at room temperature over night. A test was carried out using a secondary battery charge/discharge tester (Nagano Co., Ltd.). The test cell was charged with a constant current flow of 0.5 mA/cm² until a cell voltage of 4.2 V was reached. Discharge was effected with a constant current flow of 0.5 mA/cm² and terminated when the cell voltage declined below 2.5 V. A discharge capacity was determined. The charge/discharge test was repeated 50 cycles. A cycle retentivity after 50 cycles was determined. The results are shown in Table 1.

### Example 2

A negative electrode was prepared by adding 10% of polyvinylidene fluoride to 5 g of the negative electrode active material (conductive silicon composite powder) in Example 1 and further adding N-methylpyrrolidone to form a slurry. The slurry was coated onto one surface of a copper foil of 20 μm thick and vacuum dried at 120° C. for 1 hour. The coated foil was shaped under pressure by means of a roller press.

To 1 g of lithium powder with a particle size of 50-150 μm (Aldrich, Cat. No. 590584) was added 0.5 g of acetylene black. A xylene solution of SBR Toughtec M1943 (Asahi Chemical Industry Co., Ltd.) was then added in a concentration of 2%. To this composition, xylene which had been dried through a molecular sieve was added to form a slurry. The slurry was coated onto another surface of the copper foil of the above-prepared negative electrode in a nitrogen glove box with a dew point of −40° C. and vacuum dried at 100° C. for one hour, forming a lithium-containing film on the negative electrode, from which a disc of 2 cm² was punched out.

From a sheet Pioxcel C-100 (Pionics Co., Ltd.), a disc of 2 cm² was punched out as a positive electrode.

A testing lithium ion secondary battery was assembled in an argon glove box (dew point up to −80° C.), by using the positive electrode, the lithium-coated negative electrode, a porous film of polyethylene having a thickness of 30 μm as a separator, and a non-aqueous electrolyte solution of lithium hexafluorophosphate as a non-aqueous electrolyte in a 1/1 (volume ratio) mixture of ethylene carbonate and diethyl carbonate in a concentration of 1 mole/liter, and stacking them in the order of positive electrode, separator and negative electrode in a 2032 type coin battery housing and introducing the electrolyte solution. In this case, the lithium-containing film is positioned at the positive electrode side.

As in Example 1, the lithium ion secondary battery was tested for cycle performance. The results are shown in Table 1.

### Comparative Example 1

A negative electrode was prepared by adding 10% of polyvinylidene fluoride to the negative electrode active material (conductive silicon composite powder) in Example 1 and further adding N-methylpyrrolidone to form a slurry. The slurry was coated onto one surface of a copper foil of 20 μm thick and vacuum dried at 120° C. for 1 hour. The coated foil was shaped under pressure by means of a roller press.

From a sheet Pioxcel C-100 (Pionics Co., Ltd.), a disc of 2 cm² was punched out as a positive electrode.

A testing lithium ion secondary battery was assembled in an argon glove box (dew point up to −80° C.), by using the positive electrode, the negative electrode, a porous film of polyethylene having a thickness of 30 μm as a separator, and a non-aqueous electrolyte solution of lithium hexafluorophosphate as a non-aqueous electrolyte in a 1/1 (volume ratio) mixture of ethylene carbonate and diethyl carbonate in a concentration of 1 mole/liter, and stacking them in the order of positive electrode, separator and negative electrode in a 2032 type coin battery housing and introducing the electrolyte solution.

As in Example 1, the lithium ion secondary battery was tested for cycle performance. The results are shown in Table 1.

TABLE 1

| | | | Comparative |
|---|---|---|---|
| | Example 1 | Example 2 | Example 1 |
| 1st cycle charge quantity (mAh) | 4.10 | 4.10 | 4.10 |
| 1st cycle discharge quantity | 3.77 | 3.73 | 2.87 |
| (mAh) | | | |
| 50th cycle discharge quantity | 3.69 | 3.65 | 2.81 |
| (mAh) | | | |
| 50th cycle capacity retentivity (%) | 98 | 98 | 98 |

Japanese Patent Application No. 2006-248967 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A non-aqueous electrolyte secondary battery comprising
a negative electrode comprising a negative electrode active material containing silicon capable of intercalating and deintercalating lithium ions,
a positive electrode comprising a positive electrode active material containing an oxide, sulfide or organic polymer capable of intercalating and deintercalating lithium ions, and
a non-aqueous electrolyte solution containing a lithium salt,
said negative electrode having a lithium-containing film at least at the positive electrode side.

2. The secondary battery of claim 1 wherein the lithium-containing film comprises a metallic lithium powder which is optionally surface coated with an organic rubber, organic resin or metal carbonate, a binder, and an electric conductive agent.

3. The secondary battery of claim 1 or 2 wherein the negative electrode has a current collector sheet, and the negative electrode active material layer is formed on one surface of the current collector sheet and the lithium-containing film is formed on the negative electrode active material layer.

4. The secondary battery of claim 1 or 2 wherein the negative electrode has a current collector sheet, and the negative electrode active material layer is formed on each surface of the current collector sheet and the lithium-containing film is formed on each negative electrode active material layer.

5. A method for manufacturing a non-aqueous electrolyte secondary battery comprising a negative electrode comprising a negative electrode active material containing silicon capable of intercalating and deintercalating lithium ions, a positive electrode comprising a positive electrode active material containing an oxide, sulfide or organic polymer capable of intercalating and deintercalating lithium ions, and a non-aqueous electrolyte solution containing a lithium salt,
said method comprising the step of forming a lithium-containing film to at least the positive electrode side of the negative electrode.

6. The method of claim 5 wherein the step of forming a lithium-containing film includes coating a mixture comprising a metallic lithium powder which is optionally surface coated with an organic rubber, organic resin or metal carbonate, a binder, and an electric conductive agent directly to at least the positive electrode side of the negative electrode.

7. The method of claim 6 wherein a current collector sheet for the negative electrode is provided, and the step of forming the negative electrode active material layer on one surface of the current collector sheet and the step of coating the mixture directly on the negative electrode active material layer are included.

8. The method of claim 6 wherein a current collector sheet for the negative electrode is provided, and the step of forming the negative electrode active material layer on each surface of the current collector sheet and the step of coating the mixture directly on each negative electrode active material layer are included.

9. The method of claim 5 wherein the step of forming a lithium-containing film includes previously forming a lithium-containing film from a mixture comprising a metallic lithium powder which is optionally surface coated with an organic rubber, organic resin or metal carbonate, a binder, and an electric conductive agent and laminating the film to at least the positive electrode side of the negative electrode.

10. The method of claim 9 wherein a current collector sheet for the negative electrode is provided, and the step of forming the negative electrode active material layer on one surface of the current collector sheet and the step of laminating the film on the negative electrode active material layer are included.

11. The method of claim 9 wherein a current collector sheet for the negative electrode is provided, and the step of forming the negative electrode active material layer on each surface of the current collector sheet and the step of laminating the film on each negative electrode active material layer are included.
